(19) United States
(12) Patent Application Publication
(10) Pub. No.: US 2009/0076173 A1
(43) Pub. Date: Mar. 19, 2009

(54) Delivery System for a Hygienic Agent

(76) Inventors: Earl Philip Seitz Jr., Scottsdale, AZ (US); E. Gary Myers, Scottsdale, AZ (US); June Fine, Phoenix, AZ (US); John Salas, Mesa, AZ (US); Jesus Macias, Scottsdale, AZ (US)

Correspondence Address: THE DIAL CORPORATION, 19001 N. Scottsdale Road, SCOTTSDALE, AZ, 85255, US

(21) Appl. No.: 12/226,503

(22) PCT Filed: Apr. 19, 2007
(86) PCT No.: PCT/US2007/066933

§ 371 Date: Oct. 20, 2008

Related U.S. Application Data
(60) Provisional application No. 60/745,206, filed on Apr. 20, 2006.

(51) Int. Cl. A61Q 19/00

(52) U.S. Cl. 514/770; 514/785

(57) ABSTRACT

A delivery system for a hygienic agent according to the present invention includes an agent in a viscous paste and/or semi-solid gel form, which includes a skin benefiting composition containing cleansing and/or positive skin sensory elements. The system is configured to deliver the skin benefiting composition to the whole body or on selected, discrete parts of the body to promote a skin massaging/pleasant feel, during either a washing process or outside of a washing process.

### FIELD OF INVENTION

The present disclosure relates generally towards a system and composition configured to deliver a hygienic agent. More particularly, the system facilitates the ability to generally neatly apply a hygienic agent to discrete parts of the body. Furthermore, the system generally promotes generating a desirable skin sensory experience during application of a hygienic agent, within or outside of a typical washing process.

### BACKGROUND OF THE INVENTION

Various personal cleansing agents such as lotions, oils, and the like, are well known in the personal care industry as delivery vehicles for bodily agents. While these forms are effective for this purpose, they may not cleanse the skin and leave it clean and fresh. Additionally, most lotions and oils do not facilitate a skin massaging or other sensory benefit in the fashion that a form such as a semi-solid or paste may provide.

However, to the extent that a solid or lotion can deliver such a skin massaging or other sensory benefit, they generally require a lathering and rinsing step, like soap generally requires, as well as the need for a subsequent drying step.

### SUMMARY OF THE INVENTION

What is needed is a system for delivering a hygienic agent in a neat fashion that doesn't drip, run, irritate, or leave the user with a greasy feeling. Preferably, the hygienic agent comprises a semi-solid gel or paste to facilitate a skin sensitizing massaging aspect, and/or fragrant, eye appealing, aesthetic, or other skin benefiting element. Moreover, the system may include a “non-rinsing agent,” which allows a user to apply the hygienic agent to the whole body or various, discrete parts of the body without the need for “wash-off,” that is, without having to “rinse.” Finally, the system facilitates use either during general hygienic cleaning, as in a daily shower, or in a portable, public, fashion, “at will” throughout the day.

Embodiments of the present invention include a delivery system for a hygienic agent, which includes a skin cleansing or skin benefiting composition having a positive skin sensory element, a medium to contain and manipulate the skin benefiting composition, a non rinsing agent, and/or an element of the skin benefiting composition configured to facilitate use of the hygienic agent outside of a washing process, without the need for rinsing. In various embodiments of the present invention, the skin benefiting composition of the delivery system comprises a skin cleansing element and/or other various skin benefiting elements.

In accordance with an exemplary embodiment of the present invention, the skin benefiting composition contains a skin sensory element, wherein the skin sensory element further comprises a skin massaging element. In one aspect, the skin massaging element comprises particles to facilitate exfoliation of the skin, such as, derma-abrasives, beads, micro-beads, coarse fibers, and the like.

The present invention, in accordance with an exemplary embodiment, comprises a delivery system that incorporates a medium that further comprise a substantially gel form or a substantially viscous paste form, wherein the gel form has a viscosity of about 175,000 centipoise using a Brookfield Viscometer RVT @ 65 RPM. In an exemplary embodiment, a paste-type was measured with a Brookfield Viscometer using a T spindle at 30 RPM and found to be 140,500 centipoise. In an exemplary embodiment, the medium is configured to facilitate delivery of the skin benefiting composition, and then may generally flake off of the skin removing the unwanted soil and/or other contaminants without the need for water to rinse.

In another embodiment of the present invention, the delivery system may further include a container to house the gel or paste forms. Furthermore, the container may be configured to allow pinpoint application of the solid forms to selected, discrete parts of the body. One type of container or housing may include a portable dispenser and closure, although a traditional free standing pump or wall dispenser may be used for delivery of the cleansing gel or viscous paste.

In another embodiment of the present invention, the delivery system includes a tube or squeeze bottle for the paste or gel form. Furthermore, any of the forms could be dispensed in a roll-on or antiperspirant gel type container to facilitate pinpoint application of the delivery system to selected parts of the body.

### BRIEF DESCRIPTION OF THE DRAWINGS

These and other features, aspects and advantages of the present invention will become better understood with reference to the following description, appending claims, and accompanying drawings where:

FIG. 1 is a block diagram of a method of creating a composition configured to deliver a hygienic agent, according to an exemplary embodiment.

### DETAILED DESCRIPTION

The following description is of exemplary embodiments of the invention only, and is not intended to limit the scope, applicability or configuration of the invention in any way. Rather, the following description is intended to provide a convenient illustration for implementing various embodiments of the invention. As will become apparent, various changes can be made in the function and arrangement of the elements described in these embodiments without departing from the scope of the invention as set forth in the appended claims. For example, in the context of the present invention, a delivery system for a hygienic agent is described herein with reference to particular physical embodiments, even though the delivery system may have numerous configurations. As such, terms in the following detailed description should not generally be used to limit the delivery system to merely a delivery application for a hygienic product, but rather the delivery system may also be used in other contemplated applications.

That said, in accordance with various exemplary embodiments of the present invention and discussed in greater detail below, a delivery system for a hygienic agent generally includes a skin benefiting composition. More particularly, the skin benefiting composition includes a cleansing formula and/or at least one positive skin sensory element, a medium to contain, manipulate, and facilitate delivery of the skin benefiting composition, and a generally non-rinsing-type agent configured to facilitate use of the hygienic agent outside of a washing process without the need for rinsing.

In terms of the general skin benefiting composition, the present invention described herein, contemplates various exemplary embodiments. For example, one type of skin benefiting composition may facilitate cleansing of the skin, and another composition may be helpful in moisturizing or adding beneficial vitamins, skin aids, and the like. Another exemplary composition may focus primarily on providing just a positive skin sensory experience only, such as, cooling, heating, massaging, and the like. In other aspects, the above exemplary compositions may be combined in various ways to accommodate the needs or wants of the user, for example, a skin cleanser composition that is combined with a positive skin sensory composition.

Turning now to the various elements of the skin benefiting composition, various exemplary embodiments include a cleansing formula. The cleansing formula may include various cleansing elements, which may enhance the removal of sweat, dirt, grime, sebum soil, make-up, and other skin contaminants.

In accordance with another embodiment of the present invention, the hygienic agent includes a skin benefiting composition containing elements suitably provided to further supplement a cleansing formula and/or a hereinafter described positive skin sensory element. For example, some skin benefiting elements include, either alone or in various combinations, an antibacterial agent, an antiviral agent, an antimicrobial agent, skin and hair conditioning agents, fragrances, anti-dandruff agents, vitamins, moisturizers (humectant and occlusive) antioxidants, anti-allergy agents, skin protectants, film forming agents, sunscreens, sun-block agents, anti-acne agents, skin lightening agents, self-tanning agents, analgesics, anti-inflammatory agents, anti-irritants, anti-arthritics, ultraviolet absorbers, wound healing agents, anti-scarring agents, cooling or warming agents, aloe vera and/or other cosmetic and medicinally topically active components, and/or others not specifically mentioned herein, and/or combinations thereof.

In accordance with various exemplary embodiments, the skin benefiting composition may include at least one skin sensory element. The sensory element may provide a user with a pleasurable skin sensory experience for example, a relieving massaging experience. Such elements may include beads, emollients, balms, astringents, ointments, salves, unctions, unguents, and/or other various skin sensory elements, and/or combinations thereof.

In an exemplary embodiment, the skin benefiting composition may also include various elements other than tangible particles, abrasives, beads, etc., to contribute to a pleasurable skin sensory experience, and/or provides a luffa-type effect for exfoliation and/or enhanced soil removal. Such elements, for example, may include ingredients that promote or foster a cooling, warming, and/or soothing aspect to the skin. Furthermore, the incorporation of winter green, menthol, camphor, astringents, alcohols, and the like, may be utilized to create the sensory effects.

In accordance with various embodiments of the present invention, the delivery system of the hygienic agent includes a medium to contain and/or manipulate the skin benefiting composition. The medium, or a container that houses the medium, may be configured to facilitate delivery of the skin benefiting composition, to the whole body or to specific, discrete areas. Such exemplary mediums may include a gel or paste, for example, a squeeze tube or squeeze bottle, pumps, oval, puck, beads, roll-ons, and other dispensers capable of dispensing a gel or viscous paste, and the like.

In accordance with an embodiment of the present invention, an exemplary gel composition may include, deionized water, paraffin wax, carbomer, glycerin, propylene glycol, methylparaben, propylparaben, diazolidinyl urea, and/or other elements, and/or combinations thereof. An exemplary, non-limiting composition is illustrated by Example 1 shown below.

### EXAMPLE 1

| Material Code | Weighty % |
|---|---|
| Deionized Water | 85.25 |
| Paraffin Wax (Strahl & Pitsch, SP-1275) | 6.00 |
| Carbomer (Ultrez-20 Carbopol) | 2.0 |
| Glycerin | 3.0 |
| Propylene Glycol | 3.0 |
| Propylene Glycol/Methylparaben/Propylparaben/ | 0.75 |
| Diazolidinyl Urea | |

In an exemplary embodiment, the medium may be comprised of about 50% to 90%, by weight, deionized water. The amount of deionized water is more preferably about 80% to 90%, by weight, and most preferably about 85%, by weight.

In an exemplary embodiment, the medium may be comprised of about 1% to 10%, by weight, paraffin wax-type material. The amount of paraffin wax-type material is more preferably about 5% to 7%, by weight, and most preferably about 6%, by weight.

In an exemplary embodiment, the medium may be comprised of about 0.1% to 5%, by weight, carbomer-type material. The amount of carbomer-type material is more preferably about 1% to 3%, by weight, and most preferably about 2%, by weight.

In an exemplary embodiment, the medium may be comprised of about 0.5% to 10%, by weight, glycerin-type material. The amount of glycerin-type material is more preferably about 2% to 4%, by weight, and most preferably about 3%, by weight.

In an exemplary embodiment, the medium may be comprised of about 0.5% to 10%, by weight, propylene glycol-type material. The amount of propylene glycol-type material is more preferably about 2% to 4%, by weight, and most preferably about 3%, by weight.

In an exemplary embodiment, the medium may be comprised of about 0.1% to 5%, by weight, of a mixture of propylene glycol, methylparaben, propylparaben, and diazolidinyl urea, type material. The amount of this mixture is more preferably about 0.5% to 1%, by weight, and most preferably about 0.75%, by weight.

It will be appreciated that although this embodiment it described as to certain materials, other material having somewhat similar characteristics, and/or having somewhat similar effects are intended encompassed by this disclosure.

In accordance with an embodiment of the present invention, an exemplary paste composition may include, deionized water, paraffin wax-type material (Paraffin), hydrated magnesium aluminum silicate-type material (Veegum Granular), palmitic acid-type material (PALMAC), stearic acid-type material (STEARAC), triethanolamine-type material (TEA), and Paragon III-type material (phenoxyethanol, DMDM Hydantoin, methylparaben, and propyl paraben), DMDM Hydantion, methylparaben, propylparaben, and/or other element, and/or combination thereof. An exemplary, non-limiting composition is illustrated by Example 2, shown below.

### EXAMPLE 2

| | Batch Calculation | (over all) |
|---|---|---|
| Deionized Water | | 103.73 |
| 8.0% paraffin | 125(0.08) = | 10.00 |
| 3.0% Veegum | 125(0.03) = | 3.75 |
| 2.5% PALMAC | 125(0.025) = | 3.13 |
| 2.5% STEARAC | 125(0.025) = | 3.13 |
| 0.5% TEA | 125(0.005) = | 0.63 |
| 0.5% (48% | 125(0.005) = | 0.63 |
| phenoxyethanol, 30% | | |
| DMDM Hydantoin, 11% | | |
| methylparaben, 3% | | |
| propylparaben) | | |
| Total | | 125 |

| | Target Amounts | Actual Amounts |
|---|---|---|
| C-1 | | |
| Water | 103.73 | 103.74 |
| Veegum | 3.75 | 3.77 |
| Triethanolamine | 0.63(0.56 mL) + | Second (0.56 mL |
| | | portion) |
| 0.5% (48% | 0.63 (0.54 mL) | |
| phenoxyethanol, 30% | | |
| DMDM Hydantoin, 11% | | |
| methylparaben, 3% | | |
| propylparaben) | | |
| | | Tare (200 mL beaker) = |
| | | 102.45 |
| C-2 | | |
| Paraffin | 10.00 | 10.01 |
| PALMAC | 3.13 | 3.13 |
| STEARAC | 3.13 | 3.13 |
| | | Tare (100 mL beaker + |
| | | stir) = 65.55 |

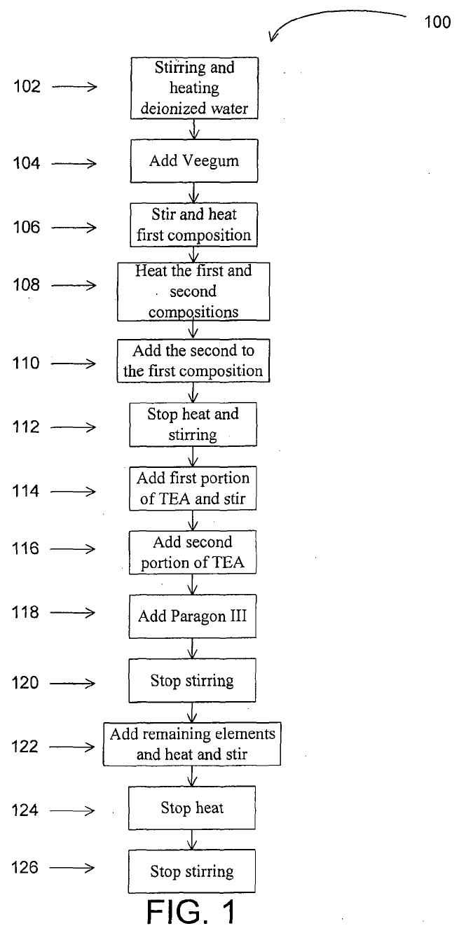

An exemplary method 100 for formulating the paste composition of Example 2 is shown in FIG. 1. In an exemplary embodiment, method 100 includes stirring and heating deionized water, 102. At about 35° C., sprinkle in Veegum accompanied by high stirring, at 104. Continue to raise the temperature to about 61° C. with continued stirring and heat control until Veegum is completely dissolved. Further raise temperature to about 77° C. with continued stirring and heat control, at 106.

The temperature of the mixture of C-1 may be raised to about 81° C., and the temperature of C-2 to about 95° C., at 108. Add C-2 drop-wise to C-1 with high stirring, at 110.

When the temperature reaches about 78.6° C., addition of C-2 is completed, and the heat and high speed stirring is stopped, at 112. Add the first TEA portion, at 114, Once the temperature reaches about 65° C., the second TEA portion is added, at 116. At a temperature of about 54° C., the Paragon III is added, at 118. Once the temperature reaches about 47.5° C., stop stirring, at 120. All remaining ingredients are then added and the heat is started until a temperature of about 97.7° C. is reached, at 122. At this point the heat is stopped, at 124. Stirring is continued for an additional 15 minutes or until the final product is uniform in appearance, at 126.

It will be appreciated that these steps are merely one embodiment, various embodiments may include more or less steps. Furthermore, portions of steps may be omitted without straying from the concepts disclosed herein.

In an exemplary embodiment, the medium may be comprised of about 50% to 98%, by weight, deionized water. The amount of deionized water is more preferably about 80% to 90%, by weight, and most preferably about 85%, by weight.

In an exemplary embodiment, the medium may be comprised of about 1% to 10%, by weight, paraffin wax-type material. The amount of paraffin wax-type material is more preferably about 7% to 9%, by weight, and most preferably about 8%, by weight.

In an exemplary embodiment, the medium may be comprised of about 0.1% to 5%, by weight, hydrated magnesium aluminum silicate-type material. The amount of hydrated magnesium aluminum silicate-type material is more preferably about 2% to 4%, by weight, and most preferably about 3%, by weight.

In an exemplary embodiment, the medium may be comprised of about 0.50% to 10%, by weight, palmitic acid-type material. The amount of palmitic acid-type material is more preferably about 1% to 4%, by weight, and most preferably about 2.5%, by weight.

In an exemplary embodiment, the medium may be comprised of about 0.50% to 10%, by weight, stearic acid-type material. The amount of stearic acid-type material is more preferably about 1% to 4%, by weight, and most preferably about 2.5%, by weight.

In an exemplary embodiment, the medium may be comprised of about 0.01% to 5%, by weight, triethanolamine-type material. The amount of triethanolamine-type material is more preferably about 0.1% to 1%, by weight, and most preferably about 0.5%, by weight.

In an exemplary embodiment, the medium may be comprised of about 0.01% to 5%, by weight, Paragon III-type material. The amount of Paragon III-type material is more preferably about 0.1% to 1%, by weight, and most preferably about 0.5%, by weight.

It will be appreciated that although this embodiment it described as to certain materials, other material having somewhat similar characteristics, and/or having somewhat similar effects may be substituted, which is intended encompassed by this disclosure.

It should be appreciated that in a typical fashion, for example, a solid agent, such as a bar, generally requires a user to work the agent, that is, apply a liquid medium, and massage the agent and liquid together to create lather. The lather is then placed on the body in the general desired area, “worked about,” and subsequently rinsed off. This often results in the lathered agent encroaching upon areas during the “working about” procedure that were not desired for application. In addition, the subsequent rinsing process needed to remove the lather often requires a drying process.

However, in an exemplary embodiment of the present invention, the solid form is configured to facilitate the ability to control and direct the hygienic agent to a particular area of the body for agent delivery. The gel or paste form is applied to a specific area without the need for a generally less viscous liquid medium, does not encroach upon undesired areas of the body, and needs no rinsing or drying process. To facilitate this process, the exemplary solid comprises a relatively easy shearing material for deposition, often referred to as “payoff.” As the user applies the agent, the friction between the skin and solid agent surfaces facilitates an amount of agent to shear off from the solid surface and thus becomes deposited upon the body. In one exemplary embodiment the agent comprises a material with shear properties from about 20,000 centipoise to about 150,000 centipoise.

In accordance with one exemplary aspect of the present invention, a gel or viscous paste embodiment may be housed within a special portable single use foil packet. For example, the aforementioned forms are housed in a package similar to the jelly packets one finds in restaurants. In this exemplary embodiment, the user opens the sealed packet and applies the hygienic cleansing product with the finger tips to the soiled area. Upon rubbing of the cleaning agent on the area to be cleansed, the soil is removed by the cleansing agent and the agent entraps the soil, and may generally flake off of the skin while holding the contaminant tightly bound. Again, the user can exercise greater control of amount and placement of the composition. The cleansing agent may also comprise various positive skin sensory elements, such as abrasives or exfoliating particles, massaging elements, emollients, astringents, and the like. In an additional embodiment, the composition is a gel or very viscous paste, and may be dosed by an applicator similar to a roll-on antiperspirant stick.

In accordance with an exemplary embodiment of the present invention, the delivery system medium may also be a gel form. The gel form provides the agent with a product that may be generally more malleable. Furthermore, the gel may be a greater viscous form than a paste-type product, for example, a semi-solid form similar to a hair gel. However, it should be appreciated that the semi-solid gel form, and the viscous toothpaste-like cleaning agent, do not suffer the disadvantages described earlier that are characteristic of lotions, oils, and other thin liquids. For example, the gel and viscous paste do not run, leak, drip, etc.

In an exemplary embodiment, the semi-solid gel form comprises a relatively easy material for deposition, for example, a material with viscous properties from about 100,000 centipoise to about 250,000 centipoise. In accordance with one exemplary aspect, the semi-solid form contains solid elements, such as massaging particles, beads, and others described herein that act as sensory elements. It should be appreciated that the delivery system in this semi-solid form also facilitates the ability for a user to pinpoint the hygienic agent to a particular area of the body for application.

In various exemplary embodiments of the present invention, the semi-solid form may be housed in a variety of different delivery configurations. For example, a semi-solid gel form may be housed in a squeezable tube having variable dispensable orifice sizes to accommodate the pinpointing ability and direct control for applying the skin benefiting composition to particular bodily areas. In another exemplary aspect, the hygienic agent in a semi-solid form is housed in a roll-on-type container. The roll-on is used in typical fashion to, again, allow for greater control in direct placement of the skin benefiting composition, and in the discrete amount desired.

In various exemplary embodiments of the present invention, the skin benefiting composition comprises materials, such as micro-beads or beads, e.g. jojoba-type beads. An advantage of micro-beads is that they provide a different skin sensitizing or massaging aspect, apart from a solid unitary type product, such as a bar or stick, and also different than a semi-solid product, such as a gel or viscous paste similar to toothpaste. In one embodiment, the beads are a separate solid medium that allow a user to manipulate a variable amount of hygienic agent, as opposed to a total product. In an embodiment, a user can dispense as many beads as desired for a particular use. The beads may comprise a variety of shapes, sizes, colors, fragrances, and the like.

In various exemplary embodiments of the present invention, the beads may include materials with a variety of properties, for example, one type may easily break apart upon application. In another embodiment, the beads include variable surface roughness to further accentuate the positive skin sensory massaging aspect. In yet another embodiment, the beads are skin temperature sensitive, requiring varying time lengths for massaging upon the skin before the beads break apart into the formulated skin benefiting composition. In still another embodiment, the beads do not fall apart, but rather comprise a material that gradually breaks down into a more viscous product or “gels” upon continued contact with the skin. In still another embodiment, the beads comprise more than one type of material, for example, the beads include a substantially solid outer core encapsulating a viscous inner agent. Upon application, the outer “harder” core bursts to release the inner agent, and the outer core acts as a massaging medium that eventually dissolves, evaporates, or is worked into the skin in conjunction with the inner agent.

It should be appreciated that in another exemplary embodiment, the beads may be incorporated into the gel or viscous paste, or other semi-solid medium to promote a different type of positive skin sensory experience.

Accordingly, pastes and/or semi-solid gels may provide the user with the ability to place the agent directly where the user intends. In contrast, solid soap bars or body washes require water and rubbing to form lather, and require rinsing with water to remove soil from the skin. These more traditional agents are more difficult to selectively apply and require a source of water. Other less viscous agents tend to drip, run, leak, irritate, or be rubbed about in areas that encroach upon an undesired area for application. The present invention may provide greater control to the user to apply the hygienic agent, and may eliminate the need for water, thereby making the product highly portable and easily applied to the specific area of the body needing cleansing.

In accordance with an exemplary embodiment of the present invention, the delivery system of the hygienic agent facilitates use of the product during a washing process, for example, in a shower, while taking a bath, when using a wash basin, and the like. The hygienic agent in this embodiment includes a cleansing formula configured to further the washing process. In another embodiment, the hygienic agent may compliment a separate cleansing agent, or may be used primarily as a skin massaging/benefiting agent.

In accordance with various exemplary embodiments of the present invention, the hygienic agent is configured for use outside of the washing process. For example, the agent is portable so that it may be used throughout the day, i.e., during work, at the gym, at school, or while travelling, somewhat similar to sanitizers. In this embodiment, the hygienic agent includes a composition, which may promote the use of the product without the need to rinse or subsequently dry. In an exemplary embodiment, the composition includes various alcohols, methanols, and the like, which promote evaporation of the medium that facilitated delivery of the skin benefiting composition.

Finally, various principles of the invention have been described in illustrative embodiments. However, many combinations and modifications of the above-described structures, arrangements, proportions, elements materials and components, used in the practice of the invention, in addition to those not specifically described, can be varied without departing from those principles.

What is claimed is:

1. A composition, comprising:
a skin benefiting agent comprising a sensory element;
a medium capable of containing and/or manipulating the skin benefiting agent; and
a non-rinsing element configured to facilitate use of the composition outside of a washing process, without the need for rinsing,
wherein the medium comprises,
about 50% to 98%, by weight, deionized water,
about 1% to 10%, by weight, paraffin wax-type material,
about 0.1% to 5%, by weight, carbomer-type material,
about 0.5% to 10%, by weight, glycerin-type material,
about 0.5% to 10%, by weight, propylene glycol-type material, and about 0.1% to 5%, by weight, of a mixture of propylene glycol, methylparaben, propylparaben, and diazolidinyl urea, type material.

2. The system according to claim 1, further comprising a container configured to hold and dispense the composition.

3. The system according to claim 1, wherein the medium comprises:
about 80% to 90%, by weight, deionized water,
about 5% to 7%, by weight, paraffin wax-type material,
about 1% to 3%, by weight, carbomer-type material,
about 2% to 4%, by weight, glycerin-type material,
about 2% to 4%, by weight, propylene glycol-type material, and
about 0.5% to 1%, by weight, of a mixture of propylene glycol, methylparaben, propylparaben, and diazolidinyl urea, type material.

4. The system according to claim 3, wherein the medium comprises:
about 85%, by weight, deionized water,
about 6%, by weight, paraffin wax-type material,
about 2%, by weight, carbomer-type material,
about 3%, by weight, glycerin-type material,
about 3%, by weight, propylene glycol-type material, and
about 0.75%, by weight, of a mixture of propylene glycol, methylparaben, propylparaben, and diazolidinyl urea, type material.

5. The system according to claim 1, wherein the skin benefiting agent comprises a cleansing agent.

6. The system according to claim 1, wherein the skin benefiting agent comprises a skin sensory element.

7. The system according to claim 6, wherein the skin sensory element comprises a skin massaging element.

8. The system according to claim 7, wherein the skin massaging element comprises a derma-abrasive, bead, micro-bead, and/or coarse fiber, and/or combinations thereof.

9. The system according to claim 1, wherein the medium comprises a generally gel form or a generally viscous paste form.

10. The system according to claim 1, wherein the medium is about 100,000 to 250,000 centipoise.

11. The system according to claim 10, wherein the medium is about 170,000 to 180,000 centipoise.

12. The system according to claim 10, wherein the medium is about 175,000 centipoise.

13. A composition, comprising:
a skin benefiting agent comprising a sensory element;
a medium capable of containing and/or manipulating the skin benefiting agent; and
a non-rinsing element configured to facilitate use of the composition outside of a washing process, without the need for rinsing,
wherein the medium comprises,
about 50% to 90%, by weight, deionized water,
about 1% to 10%, by weight, paraffin wax-type material,
about 0.1% to 5%, by weight, hydrated magnesium aluminum silicate-type material,
about 0.5% to 10%, by weight, palmitic acid-type material,
about 0.5% to 10%, by weight, stearic acid-type material,
about 0.01% to 5%, by weight, triethanolamine-type material,
about 0.01% to 5%, by weight, Paragon III-type material.

14. The system according to claim 13, further comprising a container configured to hold and dispense the composition.

15. The system according to claim 13, wherein the medium comprises:
about 80% to 90%, by weight, deionized water,
about 7% to 9%, by weight, paraffin wax-type material,
about 2% to 4%, by weight, hydrated magnesium aluminum silicate-type,
about 2% to 3%, by weight, palmitic acid-type material,
about 2% to 3%, by weight, stearic acid-type material,
about 0.1% to 1%, by weight, triethanolamine-type material,
about 0.1% to 1%, by weight, Paragon III-type material.

16. The system according to claim 15, wherein the medium comprises:
about 85%, by weight, deionized water,
about 8%, by weight, paraffin wax-type material,
about 3%, by weight, veegum-type material,
about 2.5%, by weight, palmitic acid-type material,
about 2.5%, by weight, stearic acid-type material,
about 0.5%, by weight, triethanolamine-type material,
about 0.5%, by weight, Paragon III-type material.

17. The system according to claim 13, wherein the skin benefiting agent comprises a cleansing agent.

18. The system according to claim 13, wherein the skin benefiting agent comprises a skin sensory element.

19. The system according to claim 18, wherein the skin sensory element comprises a skin massaging element.

20. The system according to claim 19, wherein the skin massaging element comprises a derma-abrasive, bead, micro-bead, and/or coarse fiber, and/or combinations thereof.

21. The system according to claim 13, wherein the medium comprises a generally gel form or a generally viscous paste form.

22. The system according to claim 13, wherein the medium is about 75,000 to 200,000 centipoise.

23. The system according to claim 22, wherein the medium is about 130,000 to 150,000 centipoise.

24. The system according to claim 22, wherein the medium is about 140,500 centipoise.

25. A method, comprising:
stirring and heating an amount of deionized water;
mixing in an amount of hydrated magnesium aluminum silicate-type material at about 35° C. to the deionized water, to create a first mixture;
adding drops of a first portion of a second mixture at about 95° C., to the first mixture at about 81° C., to form a third mixture, until the temperature of the third mixture is about 78.6° C.;
adding a first portion of triethanolamine-type material to the third mixture;
adding a second portion of triethanolamine-type material, when the temperature of the third mixture is about 65° C.;
adding an amount of Paragon III-type material, when the temperature of the third mixture is about 54° C.;
discontinuing stirring the third mixture when the temperature is about 47.5° C.;
adding a remaining portion of the second mixture, to create a final mixture; and
stirring the final mixture for about 15 minutes.

26. The method according to claim 25, wherein the second mixture comprises paraffin wax-type material, palmitic acid-type material, and/or stearic acid-type material.

27. The method according to claim 25, wherein the final mixture comprises:
about 80% to 90%, by weight, deionized water,
about 7% to 9%, by weight, paraffin wax-type material,
about 2% to 4%, by weight, hydrated magnesium aluminum silicate-type material,
about 2% to 3%, by weight, palmitic acid-type material,
about 2% to 3%, by weight, stearic acid-type material,
about 0.1% to 1%, by weight, triethanolamine-type material,
about 0.1% to 1%, by weight, Paragon III-type material.

28. The system according to claim 25, wherein the final mixture comprises:
about 85%, by weight, deionized water,
about 8%, by weight, paraffin wax-type material,
about 3%, by weight, hydrated magnesium aluminum silicate-type material,
about 2.5%, by weight, palmitic acid-type material,
about 2.5%, by weight, stearic acid-type material,
about 0.5%, by weight, triethanolamine-type material,
about 0.5%, by weight, Paragon III-type material.
